(19) United States
(12) Patent Application Publication
(10) Pub. No.: US 2013/0036609 A1
(43) Pub. Date: Feb. 14, 2013

(54) TIMING METHOD FOR A HELICAL GEAR ASSEMBLY

(71) Applicants: Edward Frisch, Antigo, WI (US); Donald Clemins, Sarasota, FL (US)

(72) Inventors: Edward Frisch, Antigo, WI (US); Donald Clemins, Sarasota, FL (US)

(21) Appl. No.: 13/206,070

(22) Filed: Aug. 9, 2011

(51) Int. Cl. B23P 11/00

(52) U.S. Cl. 29/893.1

(57) ABSTRACT

A method for timing a stage 1 pinion gear and a stage 2 helical gear includes providing a stage 1 pinion gear including a pinion apex and a stage 2 helical gear including a plurality of stage 2 helical teeth, a center bore, and a stage 2 plane. The method also includes providing a spanner wrench and a pinion stop. The method also includes placing the spanner wrench on the stage 2 helical gear, inserting a shaft of the stage 1 pinion gear into the center bore such that the spanner wrench is positioned around the stage 1 pinion gear, securing the pinion stop to the stage 2 helical gear, and rotating the spanner wrench to engage the pinion stop with the spanner wrench.

### TECHNICAL FIELD

The present invention relates to gear assemblies, particularly to timing multiple gear assemblies for a wind turbine.

### BACKGROUND OF INVENTION

Wind turbines harness energy created when a wind current impacts a fan blade, causing rotation of the turbine rotor. The rotor is coupled to a bull gear. In a conventional turbine gear train, the bull gear engages a plurality of stage 1 pinion gears. Each stage 1 pinion gear is coupled to a stage 2 helical gear, such that rotation of the bull gear induces rotation of each stage 2 helical gear. The stage 2 helical gears drive multiple output shafts, transmitting the rotational energy to a generator for conversion to electricity.

A common problem in a gear train assembly is inefficient coupling of gears, such as gaps between the gear teeth or misalignment of the gears. These inefficiencies create energy losses in the gear train, reducing the overall effectiveness of the system. Also, since the bull gear engages multiple stage 1 pinion gears, improper assembly of the gears may result in an unequal load sharing between the stage 1 pinion gears. This causes increased wear on the gears and the bearings supporting the gear shafts, which reduces the efficiency of the gear train.

### SUMMARY

A first embodiment provides a method for timing multiple gear subassemblies, the method including providing a first gear subassembly comprising a first stage 1 pinion gear and a first stage 2 helical gear, the first stage 1 pinion gear and the first stage 2 helical gear being coupled to a first shaft defining a first axis, the first stage 1 pinion gear defining a first stage 1 apex plane and the first stage 2 helical gear defining a first stage 2 plane extending through the first stage 2 helical gear and oriented substantially perpendicular to the first axis, wherein an axial distance between the first stage 1 apex plane and the first stage 2 plane defines a first apex distance. The method also includes providing a second gear subassembly comprising a second stage 1 pinion gear and a second stage 2 helical gear, the second stage 1 pinion gear and the second stage 2 helical gear being coupled to a second shaft defining a second axis, the second stage 1 pinion gear defining a second stage 1 apex plane and the second stage 2 helical gear defining a second stage 2 plane extending through the second stage 2 helical gear and oriented substantially perpendicular to the second axis, wherein an axial distance between the second stage 1 apex plane and the second stage 2 plane defines a second apex distance, and the difference between the second apex distance and the first apex distance being within a desired tolerance. The method also includes providing a bull gear defining a bull gear apex plane, placing the first stage 1 pinion gear in meshing engagement with the bull gear such that the first stage 1 apex plane is substantially coplanar with the bull gear apex plane, and placing the second stage 1 pinion gear in meshing engagement with the bull gear such that the second stage 1 apex plane is substantially coplanar to the bull gear apex plane.

A second embodiment provides a method for assembling a stage 1 pinion gear and a stage 2 helical gear. The method includes providing a stage 1 pinion gear including a shaft having a first end, a second end opposite the first end, a mating portion having a mating diameter, a stage 1 axis extending between the first end and the second end, a first stage 1 pinion gear surface having a plurality of first stage 1 pinion gear teeth, and a second stage 1 pinion gear surface having a plurality of second stage 1 pinion gear teeth; providing a stage 2 helical gear including a first side, a second side, a plurality of stage 2 helical teeth, and a center bore having a bore diameter no larger than the mating diameter, a stage 2 plane extending through the stage 2 helical gear, the stage 2 plane being parallel to the first side and offset from the first side; providing a spanner wrench including a head portion and a handle portion, the head portion including a spanner aperture and a plurality of indexers extending into the spanner aperture; and providing a pinion stop including a pair of followers, a clamp between the followers, an arm coupling the followers and the clamp, and at least one pin coupled to the arm and extending away from the followers, wherein each follower includes a follower gear surface adapted to mesh with the stage 2 helical gear surface. The method also includes heating the stage 2 helical gear to increase the bore diameter to an assembly diameter greater than the bore diameter and cooling the stage 1 pinion gear to decrease the mating diameter to less than the assembly diameter. The method includes placing the spanner wrench on the stage 2 helical gear such that the spanner aperture is centered with respect to the center bore, and inserting the mating portion of the shaft of the stage 1 pinion gear into the center bore of the stage 2 helical gear through the spanner aperture, such that each indexer is positioned between two adjacent first stage 1 pinion gear teeth and such that the stage 1 axis is perpendicular to the stage 2 plane. The method includes securing the pinion stop to the stage 2 helical gear such that each follower meshes with the stage 2 helical gear surface, rotating the spanner wrench about the stage 1 axis, and, in response to rotating the spanner wrench, engaging the pinion stop with the spanner wrench.

A third embodiment provides a method for timing multiple gear subassemblies, the method including providing a first gear subassembly comprising a first stage 1 pinion gear and a first stage 2 helical gear, the first stage 1 pinion gear including a shaft having a first end, a second end opposite the first end, a mating portion, a first stage 1 axis extending between the first end and the second end, a first pinion gear surface having a plurality of first stage 1 pinion teeth oriented in a first direction, and a second pinion gear surface having a plurality of second stage 1 pinion teeth oriented in a second direction, the first direction and second direction pointing toward a common point of intersection, wherein each first stage 1 pinion tooth includes a first tooth tip defining a first helical curve and each second stage 1 pinion tooth includes a second tooth tip defining a second helical curve, wherein the first and second helical curves of corresponding first and second stage 1 pinion teeth intersect at a first pinion apex axially located between the first stage 1 pinion gear surface and the second stage 1 pinion gear surface, the first stage 2 helical gear having a plurality of stage 2 helical teeth and including a center bore defining a first stage 2 axis, the first stage 2 helical gear defining a first stage 2 plane extending through the first stage 2 helical gear and oriented substantially perpendicular to the first stage 2 axis, wherein the mating portion of the shaft of the first stage 1 pinion gear is inserted into the center bore of the first stage 2 helical gear, wherein a distance between the first stage 1 apex plane and the first stage 2 plane defines a first apex distance. The method also includes providing a second gear subassembly comprising a second stage 1 pinion gear and a second stage 2 helical gear, the second stage 1 pinion gear including a shaft having a third end and a fourth end opposite the third end, a mating portion, a second stage 1 axis extending between the third end and the fourth end, a third pinion gear surface having a plurality of third stage 1 pinion teeth oriented in a third direction, and a fourth pinion gear surface having a plurality of fourth stage 1 pinion teeth oriented in a fourth direction, the third direction and fourth direction pointing toward a common point of intersection, wherein each third stage 1 pinion tooth includes a third tooth tip defining a third helical curve and each fourth stage 1 pinion tooth includes a fourth tooth tip defining a fourth helical curve, wherein the third and fourth helical curves of corresponding third and fourth stage 1 pinion teeth intersect at a second pinion apex axially located between the third stage 1 pinion gear surface and the fourth stage 1 pinion gear surface, the second stage 2 helical gear having a plurality of stage 2 helical teeth and including a center bore defining a second stage 2 axis, the second stage 2 helical gear defining a second stage 2 plane extending through the second stage 2 helical gear and oriented substantially perpendicular to the second stage 2 axis, wherein the mating portion of the shaft of the second stage 1 pinion gear is inserted into the center bore of the second stage 2 helical gear, wherein a distance between the second stage 1 apex plane and the second stage 2 plane defines a second apex distance substantially equal to the first apex distance. The method includes providing a bull gear having a first bull gear surface having a plurality of first helical bull gear teeth oriented in a first direction, and a second bull gear surface having a plurality of second helical bull gear teeth oriented in a second direction such that the first direction and the second direction point towards a common point of intersection, wherein each first helical bull gear tooth includes a first bull gear tooth tip defining a first bull gear helical curve, wherein each second helical bull gear tooth includes a second bull gear tooth tip defining a second bull gear helical curve, wherein the first and second bull gear helical curves of corresponding first and second helical bull gear teeth intersect at a bull gear apex located between the first bull gear surface and the second bull gear surface, and a bull gear apex plane is defined by the locus of apices for each pair of corresponding first and second helical bull gear teeth on the first and second bull gear surfaces. The method also includes placing the first and second pinion gear surfaces of the first gear subassembly in meshing engagement with the first and second helical bull gear surfaces, respectively, and placing the third and fourth pinion gear surfaces of the second gear subassembly in meshing engagement with the first and second helical bull gear surfaces, respectively, such that the first pinion apex and the second pinion apex are substantially coplanar with the bull gear apex plane.

Other aspects of the invention will become apparent by consideration of the detailed description and accompanying drawings.

### BRIEF DESCRIPTION OF THE DRAWINGS

FIG. 1 is a perspective view of a main gear assembly.

FIG. 2 is an exploded view of the main gear assembly of FIG. 1.

FIG. 3 is a side view of a bull gear.

FIG. 4 is a perspective view of a gear subassembly.

FIG. 5 is an exploded side view of the gear subassembly of FIG. 4.

FIG. 6 is a side view of the gear subassembly of FIG. 4.

FIG. 7 is an enlarged view of a portion of the gear subassembly of FIG. 6.

FIG. 8 is a perspective view of a spanner wrench.

FIG. 9 is a perspective view of a pinion stop.

FIG. 10 is a perspective view of the gear subassembly at a first stage of assembly.

FIG. 11 is a perspective view of the gear subassembly at a second stage of assembly.

FIG. 12 is an enlarged perspective view of the second stage of assembly of FIG. 11.

FIG. 13 is a perspective view of the gear assembly at a third stage of assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

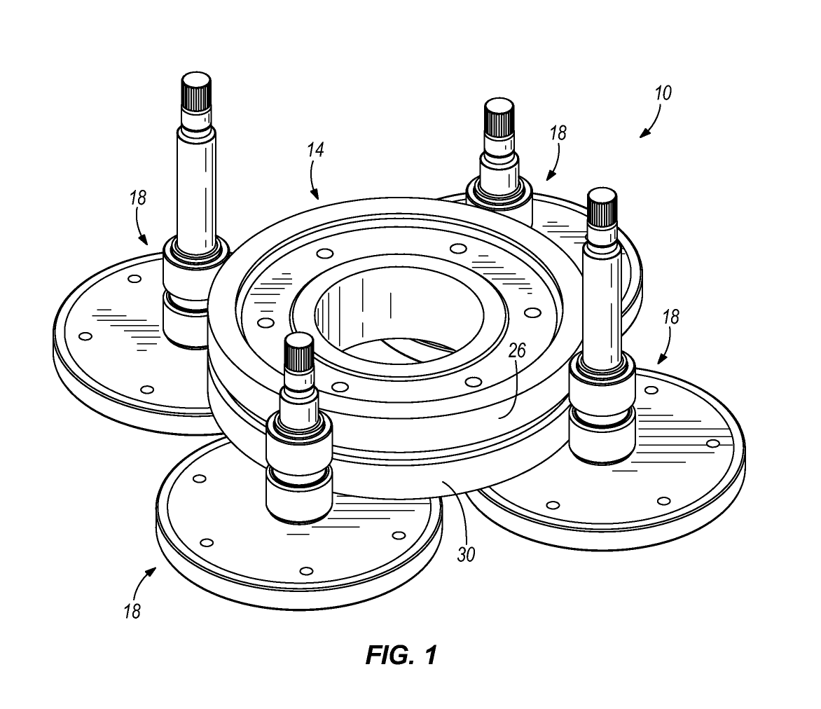

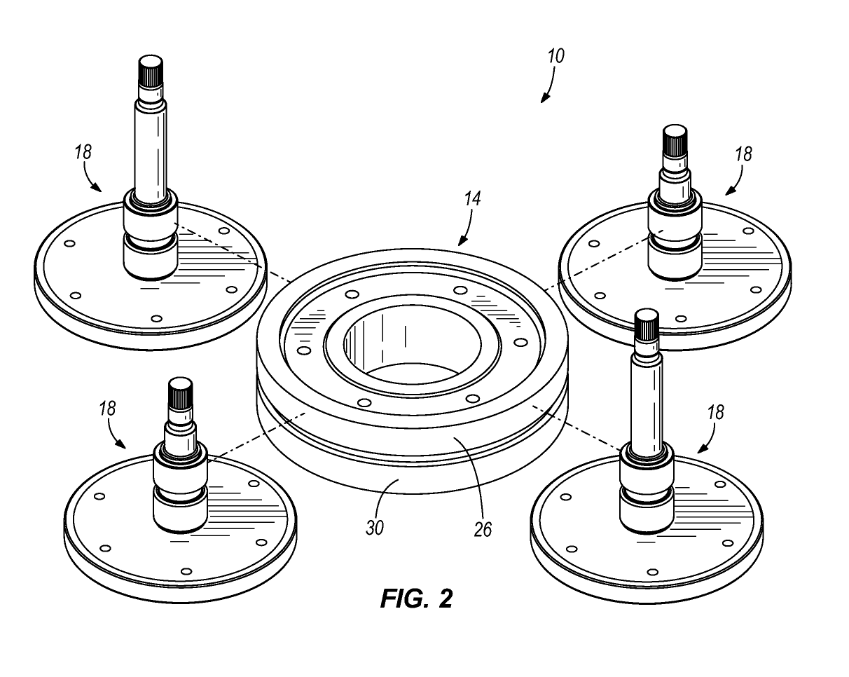

FIGS. 1 and 2 show a main gear assembly 10 for transmitting power from an input source, such as a wind turbine rotor (not shown). The main gear assembly 10 comprises a bull gear 14 meshing with multiple gear subassemblies 18. In the illustrated embodiment, the bull gear 14 meshes with four gear subassemblies 18, positioned at 90° intervals around the circumference of the bull gear 14. The bull gear 14 includes a first bull gear surface 26 and a second bull gear surface 30. For simplicity, the first bull gear surface 26 and the second bull gear surface 30 are shown schematically in FIGS. 1 and 2, without the gear teeth details. As illustrated herein, the gear teeth for all gear surfaces are generally shown in a schematic fashion, and any detailed illustration of gear teeth is intended to be representative.

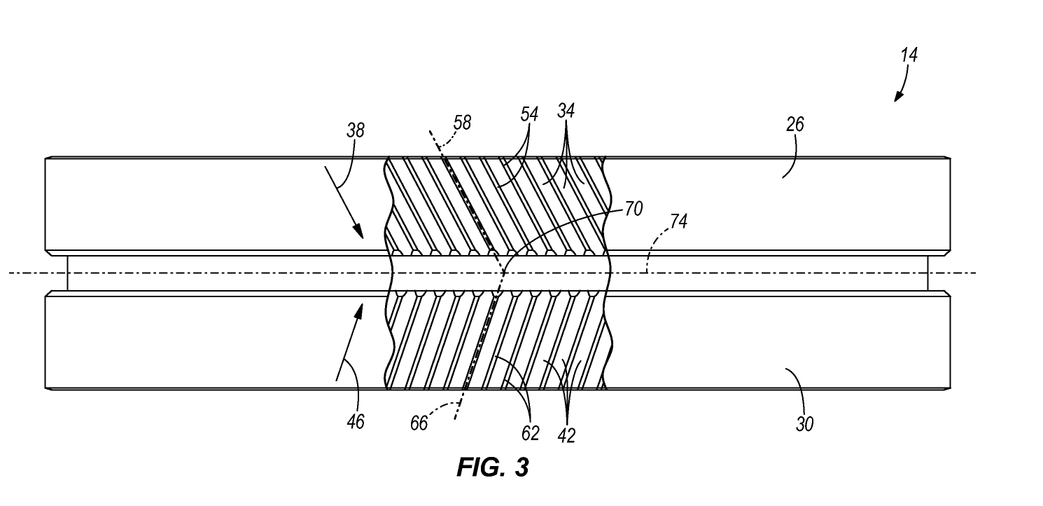

As shown in FIG. 3, the first bull gear surface 26 includes a plurality of first helical gear teeth 34 oriented in a first direction 38, and the second bull gear surface 30 includes a plurality of second helical gear teeth 42 oriented in a second direction 46. The first direction 38 and the second direction 46 point toward a point of intersection. Each first helical gear tooth 34 of the first bull gear surface 26 includes a first tooth tip 54 defining a first helical curve 58. Similarly, each second helical gear tooth 42 of the second bull gear surface 30 includes a second tooth tip 62 defining a second helical curve 66. Each first helical curve 58 intersects a corresponding second helical curve 66 at a bull gear apex 70. The bull gear apex 70 is located between the first bull gear surface 26 and the second bull gear surface 30. The locus of bull gear apices 70 approximately defines a bull gear apex plane 74. In one embodiment, the first helical gear teeth 34 and the second helical gear teeth 42 may be substantially symmetric about the bull gear apex plane 74 located between the first bull gear surface 26 and the second bull gear surface 30.

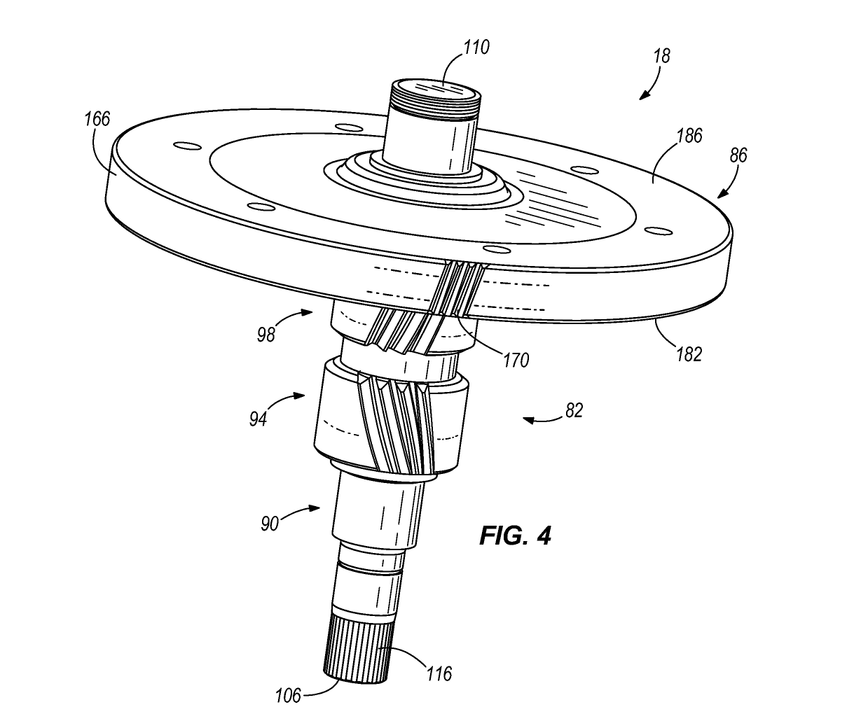

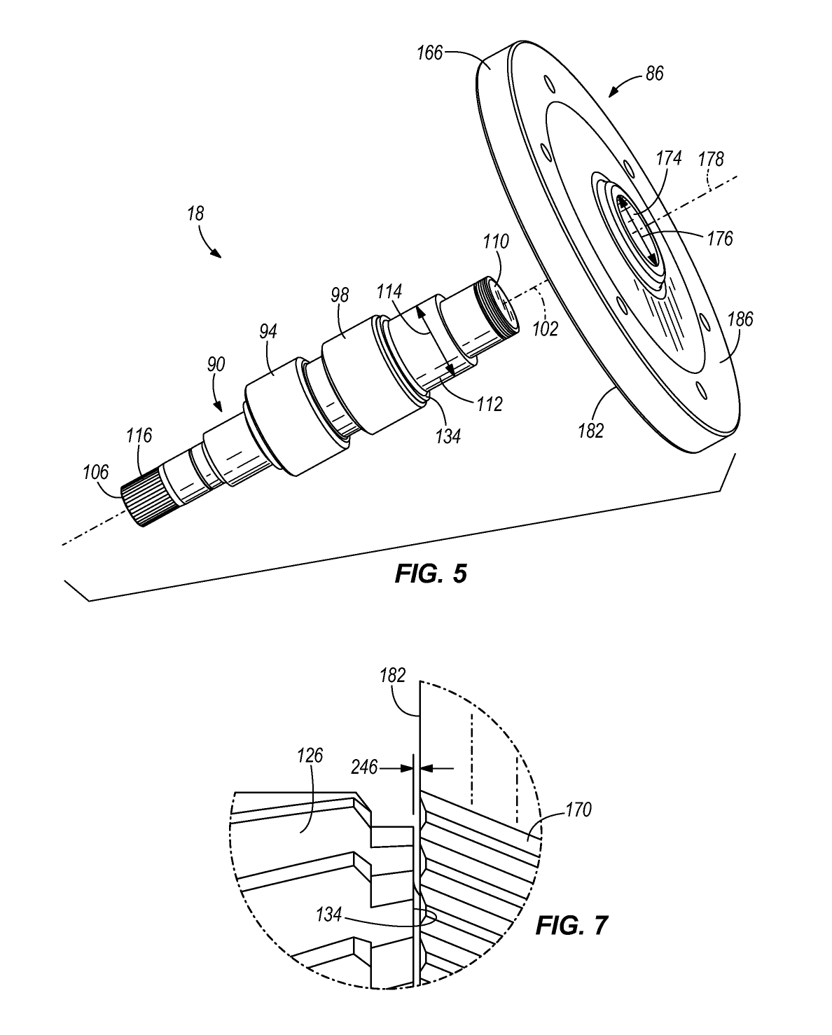

As shown in FIGS. 4 and 5, each gear subassembly 18 comprises a stage 1 pinion gear 82 and a stage 2 helical gear 86. The stage 1 pinion gear 82 includes a shaft 90, a first pinion gear surface 94 and a second pinion gear surface 98. The shaft 90 defines a stage 1 axis 102 (FIG. 5). As used herein, the term “axial” and variants thereof refer to a dimension that is parallel to the stage 1 axis 102. The shaft 90 has a first end 106, a second end 110, and a mating portion 112 having a mating diameter 114 (FIG. 5). The first end 106 of the shaft 90 includes a spline 116 that is coupled to a brake (not shown) to control the rotation speed of the shaft 90. In one embodiment, the brake may comprise a hydraulic disc. In the illustrated embodiment, the shaft 90 of each gear subassembly 18 in the main gear assembly 10 (FIG. 1) includes the spline 116. Alternatively, only some of the shafts 90 may include the spline 116 for coupling to the brake.

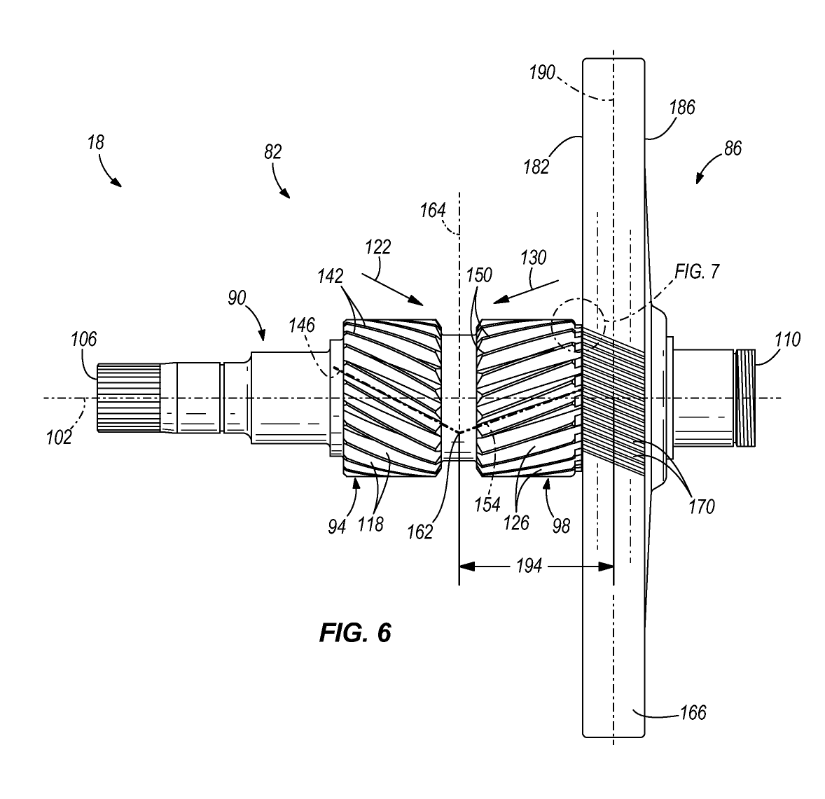

As shown in FIG. 6, the first pinion gear surface 94 is positioned between the first end 106 and the mating portion 112 and includes a plurality of first helical pinion teeth 118 oriented in a first direction 122. The second pinion gear surface 98 is positioned between the first pinion gear surface 94 and the mating portion 112 and includes a plurality of second helical pinion teeth 126 oriented in a second direction 130. The first direction 122 and the second direction 130 point toward a point of intersection. In one embodiment, the first helical pinion teeth 118 and the second helical pinion teeth 126 may be substantially symmetric about a mirror plane located between the first pinion gear surface 94 and the second pinion gear surface 98 and oriented perpendicular to the stage 1 axis 102. As seen in FIG. 5, the second pinion gear surface 98 includes a pinion shoulder 134 defined by an edge proximate the mating portion 112 of the shaft 90.

As shown in FIG. 6, each first helical pinion tooth 118 includes a first tooth tip 142 defining a first helical curve 146. Similarly, each second helical pinion tooth 126 includes a second tooth tip 150 defining a second helical curve 154. Each first helical curve 146 intersects a corresponding second helical curve 154 at a pinion apex 162. The pinion apex 162 is located between the first pinion gear surface 94 and the second pinion gear surface 98. A pinion apex 162 exists for each pair of corresponding teeth 118, 126 on the first pinion gear surface 94 and the second pinion gear surface 98. Although a timing relationship may be established using a pinion apex defined by any pair of corresponding teeth 118, 126, for purposes of this description the pinion apex of interest is pinion apex 162. The locus of pinion apices 162 defines a pinion apex plane 164. The stage 1 pinion gear 82 is formed such that an axial distance between the pinion apex plane 164 and the pinion shoulder 134 (FIG. 7) is known.

Referring again to FIGS. 4 and 5, the stage 2 helical gear 86 includes a stage 2 helical gear surface 166 including a plurality of stage 2 helical teeth 170 (FIG. 4) and a center bore 174 (FIG. 5) having a bore diameter 176, and the center bore 174 forms an interference fit with the shaft 90. The center bore 174 defines a stage 2 axis 178 (FIG. 5). The stage 2 helical gear 86 includes a first side 182 and a second side 186. As shown in FIG. 6, the stage 2 helical gear 86 defines a stage 2 plane 190 that is parallel to and offset from the first side 182 of the stage 2 helical gear 86. The stage 2 plane 190 is perpendicular to the stage 2 axis 178.

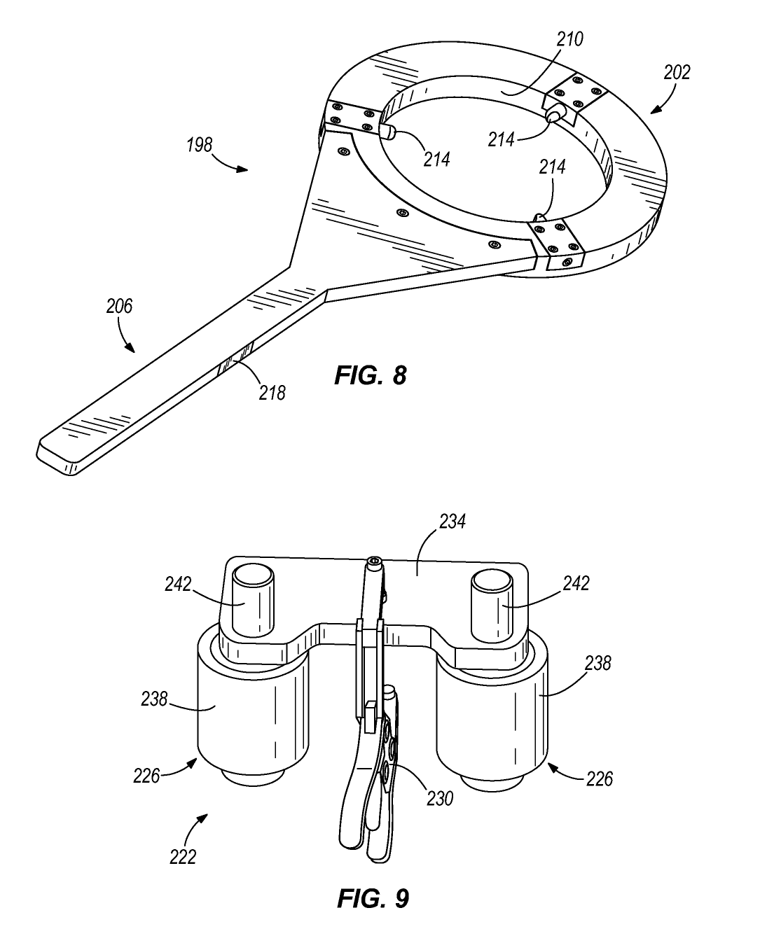

FIG. 8 shows a spanner wrench 198. The spanner wrench 198 includes a head portion 202 and a handle portion 206. The head portion 202 includes a spanner aperture 210 and a plurality of indexers 214 extending into the spanner aperture 210. In the illustrated embodiment, the head portion 202 has a ring shape and includes three indexers 214 spaced apart around the inner perimeter of the head portion 202. The handle portion 206 includes a handle stop 218. In the illustrated embodiment, the handle stop 218 is a machined surface on an edge of the handle portion 206. In an alternative embodiment, the handle stop 218 may include a grooved or notched surface, or the handle stop 218 may include a spacer mounted onto the edge of the handle portion 206. The handle stop 218 is formed such that when each indexer 214 is placed between adjacent second helical pinion teeth 126 of the second pinion gear surface 98, a positional relationship is established between the handle stop 218 and the pinion apex 162. That is, the handle stop 218 defines a point at a known radial position in relation to the pinion apex 162. In addition, the position of the indexers 214 around the inner perimeter can be adjusted to calibrate the positional relationship between the handle stop 218 and the indexers 214.

FIG. 9 shows a pinion stop 222. The pinion stop 222 includes a pair of followers 226, at least one clamp 230 positioned between the followers 226, and an arm 234 coupling the followers 226 to the clamp 230. Each follower 226 includes a follower gear surface 238 adapted to mesh with the stage 2 helical gear surface 166. The followers 226 are fixed with respect to the arm 234 and do not rotate. Each follower 226 also includes a protruding pin 242. The followers 226 are spaced such that when the followers 226 are mounted on the stage 2 helical gear 86, a positional relationship is established between one of the stage 2 helical teeth 170 and at least one of the pins 242 on the pinion stop 222. That is, the pin 242 defines a point at a known radial position in relation to a specified stage 2 helical tooth 170.

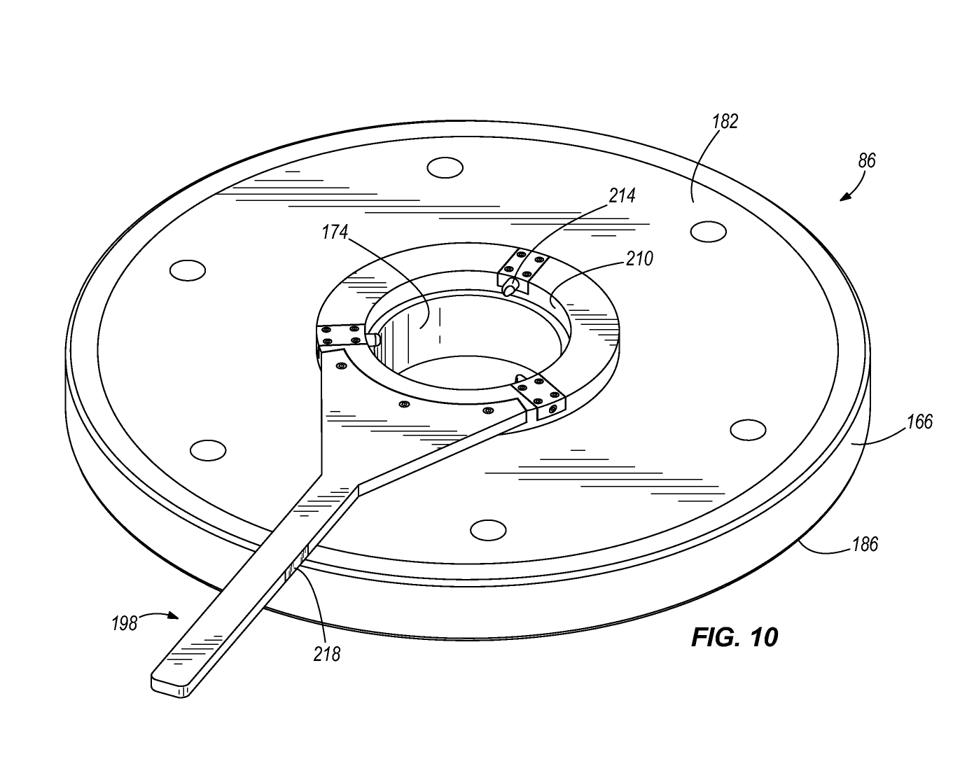

Prior to assembly, the stage 2 helical gear 86 is heated to increase the diameter of the center bore 174 to an assembly diameter that is greater than the bore diameter 176. The stage 1 pinion gear 82 is cooled to decrease the diameter of the mating portion 112 to a diameter that is less than the assembly diameter. FIGS. 10-13 illustrate the process for timing the gear subassembly 18. As shown in FIG. 10, while the stage 2 helical gear 86 is in a heated state, the spanner wrench 198 is positioned on the first side 182 of the stage 2 helical gear 86 such that the spanner aperture 210 is substantially centered with respect to the center bore 174.

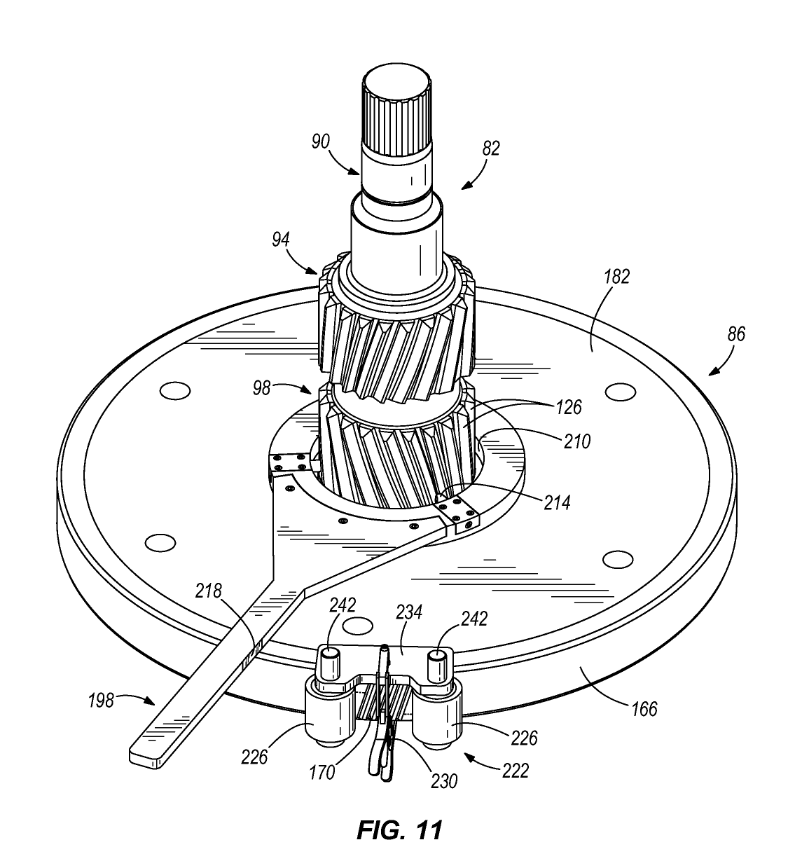

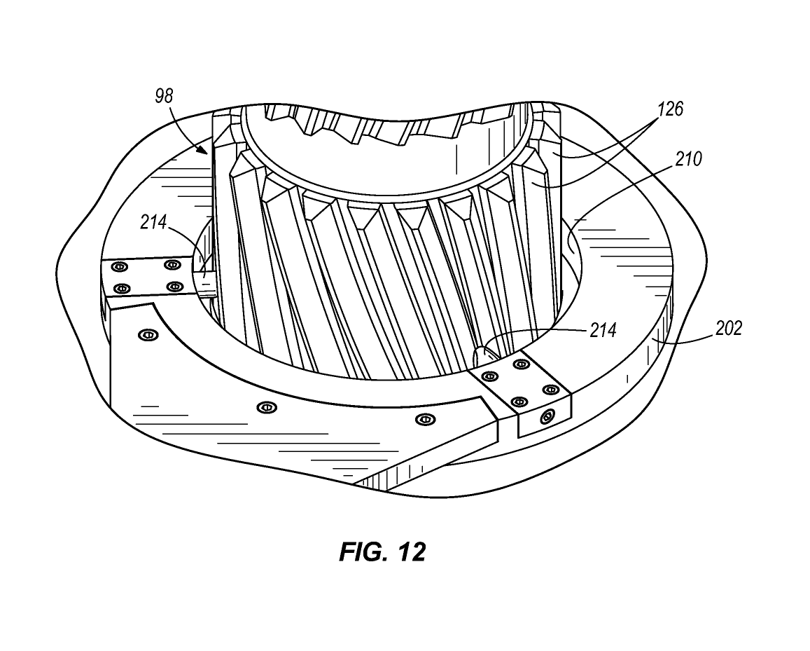

As shown in FIG. 11, the pinion stop 222 is mounted onto the stage 2 helical gear 86. One of the stage 2 helical teeth 170 is selected to establish a timing relationship with the pinion apex 162. The followers 226 are then placed in meshing engagement with the stage 2 helical teeth 170 such that at least one of the protruding pins 242 establishes a fixed positional relationship with the selected stage 2 helical tooth 170. The clamp 230 is then tightened about the first side 182 and the second side 186 of the stage 2 helical gear 86 to secure the pinion stop 222 in place. In other embodiments, multiple clamps 230 may be used to secure the pinion stop 222.

As shown in FIGS. 11 and 12, the second end 110 of the pinion shaft 90 is inserted into the center bore 174 and spanner aperture 210 such that the mating portion 112 is positioned within the center bore 174 and the stage 1 axis 102 is substantially perpendicular to the stage 2 plane 190. Stated another way, the stage 1 axis 102 is substantially aligned with the stage 2 axis 178 (FIG. 5). The indexers 214 are positioned within grooves located between adjacent second helical pinion teeth 126. The pinion shaft 90 is inserted until the pinion shoulder 134 is engaged with the first side 182 of the stage 2 helical gear 86. The pinion shoulder 134 engages the first side 182 of the stage 2 helical gear 86 when the shoulder 134 abuts the first side 182. The distance separating the pinion shoulder 134 and the first side 182 of the stage 2 helical gear 86 defines an axial gap 246 (FIG. 7) that can be measured. The pinion shoulder 134 acts as a mechanical stop for the stage 1 pinion gear 82. Because the axial distance between the pinion apex 162 and the pinion shoulder 134 is known, and the offset distance between the stage 2 plane 190 and the first side 182 of the stage 2 helical gear 86 is also known, therefore the stage 2 plane 190 lies a fixed axial distance from the pinion apex 162. The axial distance between the pinion apex 162 and the stage 2 plane 190 defines an apex dimension 194 (FIG. 6).

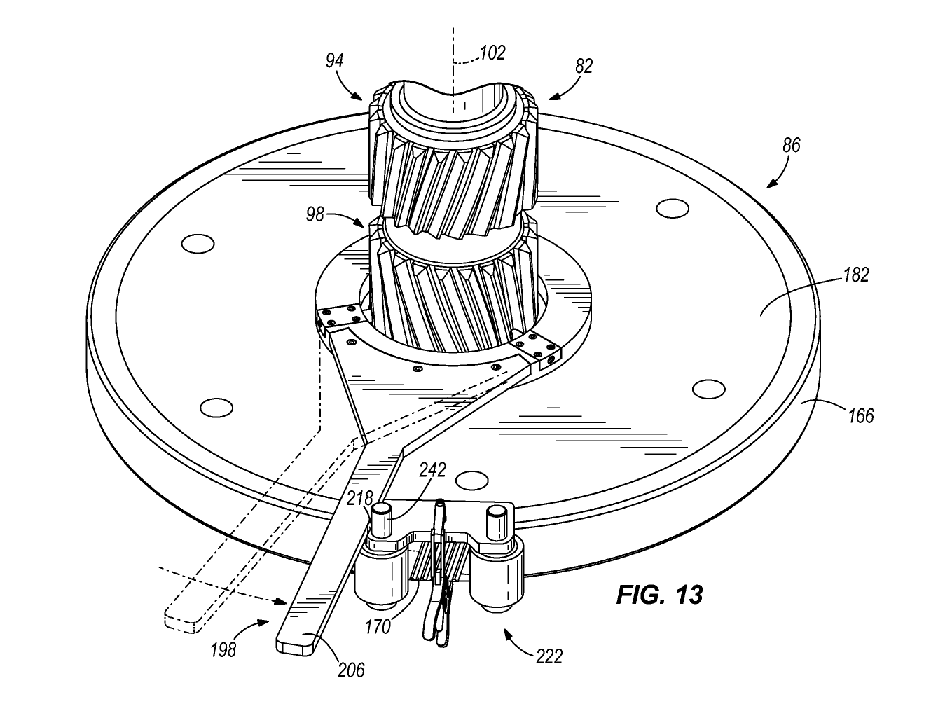

Referring now to FIG. 13, while stage 2 helical gear 86 is hot and stage 1 pinion gear 82 is cold such that the mating portion 112 has a smaller diameter than the diameter of the center bore 174, the spanner wrench 198 is rotated about the stage 1 axis 102 until the wrench 198 engages the pinion stop 222. In the illustrated embodiment, the wrench 198 engages the pinion stop 222 when the handle stop 218 contacts the protruding pin 242. During rotation of the wrench 198, the pinion shoulder 134 remains engaged with the first side 182 of the stage 2 helical gear 86. Because a positional relationship exists between the handle stop 218 and the pinion apex 162, and a positional relationship exists between the selected stage 2 helical tooth 170 and at least one of the protruding pins 242, a positional relationship between the pinion apex 162 and the selected stage 2 helical tooth 170 is therefore established when the handle stop 218 contacts the protruding pin 242. That is, the pinion apex 162 is brought to a position that is a fixed angular distance from the selected stage 2 helical tooth 170.

The angular distance is also referred to as a timing relationship. Once this timing relationship is known, it is possible to consistently assemble additional gear subassemblies 18 having identical timing relationships between the stage 1 pinion gear 82 and stage 2 helical gear 86. Thus, the method provides a manner of consistently assembling gear subassemblies 18 (FIG. 4) to produce a known timing relationship between the pinion apex 162 (FIG. 6) and a desired stage 2 helical tooth 170. Therefore, the method can produce multiple gear subassemblies 18 that have similar apex dimensions 194. Stated another way, each gear subassembly 18 has an apex dimension 194 that is within a desired tolerance of the other gear subassemblies 18 that are produced using the method described above.

Knowledge of the timing relationship allows the user to predict the relative positions of the stage 1 pinion gear 82 and the stage 2 helical gear 86 for each gear subassembly 18 (FIG. 4), which aids in synchronizing the gear subassemblies 18 when they are mounted onto the main gear assembly 10. The identical timing relationship also insures that the gear subassemblies 18 properly mesh with the bull gear 14 and any additional output gears positioned between the stage 2 helical gears 86. In addition, the fact that each gear subassembly 18 is identically timed provides more equal load sharing between the gear subassemblies 18.

After the timing relationship is established between the pinion apex 162 and the stage 2 helical tooth 170, the stage 1 pinion gear 82 is allowed to warm, which causes the diameter of the mating portion 112 (FIG. 5) to increase. Similarly, the stage 2 helical gear 86 is allowed to cool, causing the diameter of the center bore 174 (FIG. 5) to decrease. This process causes the mating portion 112 to form an interference fit with the center bore 174. During this cooling phase, the axial gap 246 is maintained within the desired tolerance. In this manner, the mating stage 1 pinion gear 82 and stage 2 helical gear 86 form the gear subassembly 18 (FIG. 4).

In another embodiment, the handle stop 218 and the protruding pins 242 may be adjustable. The user may adjust the handle stop 218 by adding a spacer onto the edge of the handle portion 206, or moving the protruding pins 242 toward or away from one another. By calibrating the spanner wrench 198 and pinion stop 222, the user can customize the timing relationship.

The gear subassembly 18 is positioned such that the stage 1 pinion gear 82 engages the bull gear 14. The first pinion gear surface 94 of the stage 1 pinion gear 82 is positioned to mesh with the first bull gear surface 26, and the second pinion gear surface 98 of the stage 1 pinion gear 82 is positioned to mesh with the second bull gear surface 30. The stage 1 pinion gear 82 is aligned with the bull gear 14 such that each pinion apex 162 is coplanar with the bull gear apex plane 74. Stated another way, the stage 1 pinion gear 82 and the bull gear 14 are aligned such that the pinion apex plane 164 and the bull gear apex plane 74 are coplanar. The main gear assembly 10 is formed by similarly positioning the other gear subassemblies 14 to engage the bull gear 14 along the circumference of the bull gear 14.

Thus, the invention provides, among other things, a method for establishing a consistent timing relationship between multiple helical gears. Various features and advantages of the invention are set forth in the following claims.

What is claimed is:

1. A method for timing multiple gear subassemblies, the method comprising:
providing a first gear subassembly comprising a first stage 1 pinion gear and a first stage 2 helical gear, the first stage 1 pinion gear and the first stage 2 helical gear being coupled to a first shaft defining a first axis, the first stage 1 pinion gear defining a first stage 1 apex plane and the first stage 2 helical gear defining a first stage 2 plane extending through the first stage 2 helical gear and oriented substantially perpendicular to the first axis, wherein an axial distance between the first stage 1 apex plane and the first stage 2 plane defines a first apex distance;
providing a second gear subassembly comprising a second stage 1 pinion gear and a second stage 2 helical gear, the second stage 1 pinion gear and the second stage 2 helical gear being coupled to a second shaft defining a second axis, the second stage 1 pinion gear defining a second stage 1 apex plane and the second stage 2 helical gear defining a second stage 2 plane extending through the second stage 2 helical gear and oriented substantially perpendicular to the second axis, wherein an axial distance between the second stage 1 apex plane and the second stage 2 plane defines a second apex distance, and the difference between the second apex distance and the first apex distance being within a desired tolerance;
providing a bull gear defining a bull gear apex plane;
placing the first stage 1 pinion gear in meshing engagement with the bull gear such that the first stage 1 apex plane is substantially coplanar with the bull gear apex plane; and
placing the second stage 1 pinion gear in meshing engagement with the bull gear such that the second stage 1 apex plane is substantially coplanar to the bull gear apex plane.

2. The method of claim 1, wherein the first stage 1 pinion gear includes
a first pinion gear surface having a plurality of first helical pinion teeth oriented in a first direction; and
a second pinion gear surface having a plurality of second helical pinion teeth oriented in a second direction, the first direction and second direction pointing toward a common point of intersection,
wherein each first helical pinion tooth includes a first tooth tip defining a first helical curve and each second helical pinion tooth includes a second tooth tip defining a second helical curve, the first and second helical curves of corresponding first and second helical pinion teeth intersecting at a first pinion apex,
wherein the locus of first pinion apices defines the first apex plane.

3. The method of claim 2, wherein the second stage 2 pinion gear includes
a third pinion gear surface having a plurality of third helical pinion teeth oriented in a third direction; and
a fourth pinion gear surface having a plurality of fourth helical pinion teeth oriented in a fourth direction, the third direction and fourth direction pointing toward a common point of intersection,
wherein each third helical pinion tooth includes a third tooth tip defining a third helical curve and each fourth helical pinion tooth includes a fourth tooth tip defining a fourth helical curve, the third and fourth helical curves of corresponding third and fourth helical pinion teeth intersecting at a second pinion apex,
wherein the locus of second pinion apices defines the second apex plane.

4. The method of claim 3, wherein the first direction and the second direction are substantially symmetric about a mirror plane perpendicular to the first axis and located between the first pinion gear surface and the second pinion gear surface, and
the third direction and the fourth direction are substantially symmetric about a mirror plane perpendicular to the second axis and located between the third pinion gear surface and the fourth pinion gear surface.

5. A method for assembling a stage 1 pinion gear and a stage 2 helical gear, the method comprising:
providing a stage 1 pinion gear including a shaft having a first end, a second end opposite the first end, a mating portion having a mating diameter, a stage 1 axis extending between the first end and the second end, a first stage 1 pinion gear surface having a plurality of first stage 1 pinion gear teeth, and a second stage 1 pinion gear surface having a plurality of second stage 1 pinion gear teeth;
providing a stage 2 helical gear including a first side, a second side, a plurality of stage 2 helical teeth, and a center bore having a bore diameter no larger than the mating diameter, a stage 2 plane extending through the stage 2 helical gear, the stage 2 plane being parallel to the first side and offset from the first side;
providing a spanner wrench including a head portion and a handle portion, the head portion including a spanner aperture and a plurality of indexers extending into the spanner aperture;
providing a pinion stop including a pair of followers, a clamp between the followers, an arm coupling the followers and the clamp, each follower including a protruding pin and a follower gear surface adapted to mesh with the stage 2 helical gear surface;
heating the stage 2 helical gear to increase the bore diameter to an assembly diameter greater than the bore diameter;
cooling the stage 1 pinion gear to decrease the mating diameter to less than the assembly diameter;
placing the spanner wrench on the stage 2 helical gear such that the spanner aperture is centered with respect to the center bore;
inserting the mating portion of the shaft of the stage 1 pinion gear into the center bore of the stage 2 helical gear through the spanner aperture, such that each indexer is positioned between two adjacent first stage 1 pinion gear teeth and such that the stage 1 axis is perpendicular to the stage 2 plane;
securing the pinion stop to the stage 2 helical gear such that each follower meshes with the stage 2 helical gear surface;
rotating the spanner wrench about the stage 1 axis; and
in response to rotating the spanner wrench, engaging the pinion stop with the spanner wrench.

6. The method of claim 5, wherein engaging the pinion stop includes bringing the handle stop of the spanner wrench into contact with the pin.

7. The method of claim 5, further comprising allowing the stage 1 pinion gear to warm and allowing the stage 2 helical gear to cool so that the mating portion of the shaft forms an interference fit with the center bore.

8. The method of claim 7, wherein an edge of the first stage 1 pinion gear surface proximate the mating portion of the stage 1 pinion gear.

9. The method of claim 8, wherein inserting the mating portion into the center bore includes creating an axial gap defined by an axial distance between the first surface of the stage 2 helical gear and the pinion shoulder.

10. The method of claim 9, further comprising maintaining the axial gap within a specified tolerance as the spanner wrench is rotated and as the stage 2 helical gear cools.

11. The method of claim 5, wherein the first stage 1 pinion gear teeth are oriented in a first direction, and the second stage 1 pinion gear teeth are oriented in a second direction, the first direction and second direction pointing toward a common point of intersection.

12. The method of claim 11, wherein each first stage 1 pinion gear tooth includes a first tooth tip defining a first helical curve, wherein each second stage 1 pinion gear tooth includes a second tooth tip defining a second helical curve, wherein the first and second helical curves of corresponding first and second stage 1 pinion gear teeth intersect at a pinion apex.

13. The method of claim 12, wherein inserting the mating portion of the shaft into the center bore such that each indexer is positioned between two adjacent first stage 1 pinion gear teeth establishes a positional relationship between the pinion apex and a handle stop defined by an edge of the handle portion.

14. The method of claim 12, further comprising defining an apex distance as a distance between the pinion apex and the stage 2 plane.

15. The method of claim 12, wherein securing the pinion stop establishes a positional relationship between each protruding pin and a selected stage 2 helical gear tooth.

16. A method for timing multiple gear subassemblies, the method comprising:
providing a first gear subassembly comprising a first stage 1 pinion gear and a first stage 2 helical gear, the first stage 1 pinion gear including a shaft having a first end, a second end opposite the first end, a mating portion, a first stage 1 axis extending between the first end and the second end, a first pinion gear surface having a plurality of first stage 1 pinion teeth oriented in a first direction, and a second pinion gear surface having a plurality of second stage 1 pinion teeth oriented in a second direction, the first direction and second direction pointing toward a common point of intersection, wherein each first stage 1 pinion tooth includes a first tooth tip defining a first helical curve and each second stage 1 pinion tooth includes a second tooth tip defining a second helical curve, wherein the first and second helical curves of corresponding first and second stage 1 pinion teeth intersect at a first pinion apex axially located between the first stage 1 pinion gear surface and the second stage 1 pinion gear surface, the first stage 2 helical gear having a plurality of stage 2 helical teeth and including a center bore defining a first stage 2 axis, the first stage 2 helical gear defining a first stage 2 plane extending through the first stage 2 helical gear and oriented substantially perpendicular to the first stage 2 axis, wherein the mating portion of the shaft of the first stage 1 pinion gear is inserted into the center bore of the first stage 2 helical gear, wherein a distance between the first stage 1 apex plane and the first stage 2 plane defines a first apex distance;
providing a second gear subassembly comprising a second stage 1 pinion gear and a second stage 2 helical gear, the second stage 1 pinion gear including a shaft having a third end and a fourth end opposite the third end, a mating portion, a second stage 1 axis extending between the third end and the fourth end, a third pinion gear surface having a plurality of third stage 1 pinion teeth oriented in a third direction, and a fourth pinion gear surface having a plurality of fourth stage 1 pinion teeth oriented in a fourth direction, the third direction and fourth direction pointing toward a common point of intersection, wherein each third stage 1 pinion tooth includes a third tooth tip defining a third helical curve and each fourth stage 1 pinion tooth includes a fourth tooth tip defining a fourth helical curve, wherein the third and fourth helical curves of corresponding third and fourth stage 1 pinion teeth intersect at a second pinion apex axially located between the third stage 1 pinion gear surface and the fourth stage 1 pinion gear surface, the second stage 2 helical gear having a plurality of stage 2 helical teeth and including a center bore defining a second stage 2 axis, the second stage 2 helical gear defining a second stage 2 plane extending through the second stage 2 helical gear and oriented substantially perpendicular to the second stage 2 axis, wherein the mating portion of the shaft of the second stage 1 pinion gear is inserted into the center bore of the second stage 2 helical gear, wherein a distance between the second stage 1 apex plane and the second stage 2 plane defines a second apex distance substantially equal to the first apex distance;
providing a bull gear having a first bull gear surface having a plurality of first helical bull gear teeth oriented in a first direction, and a second bull gear surface having a plurality of second helical bull gear teeth oriented in a second direction such that the first direction and the second direction point towards a common point of intersection, wherein each first helical bull gear tooth includes a first bull gear tooth tip defining a first bull gear helical curve, wherein each second helical bull gear tooth includes a second bull gear tooth tip defining a second bull gear helical curve, wherein the first and second bull gear helical curves of corresponding first and second helical bull gear teeth intersect at a bull gear apex located between the first bull gear surface and the second bull gear surface, and a bull gear apex plane is defined by the locus of apices for each pair of corresponding first and second helical bull gear teeth on the first and second bull gear surfaces;
placing the first and second pinion gear surfaces of the first gear subassembly in meshing engagement with the first and second helical bull gear surfaces, respectively; and
placing the third and fourth pinion gear surfaces of the second gear subassembly in meshing engagement with the first and second helical bull gear surfaces, respectively, such that the first pinion apex and the second pinion apex are substantially coplanar with the bull gear apex plane.
